(19) United States
(12) Patent Application Publication
(10) Pub. No.: US 2024/0231336 A1
(43) Pub. Date: Jul. 11, 2024

(54) MANAGING DYNAMICALLY ADAPTIVE SUPPLY NETWORK AND SYSTEM THEREFOR

(71) Applicant: Tata Consultancy Services Limited, Mumbai (IN)

(72) Inventor: Vinay Vasant KULKARNI, Pune (IN)

(73) Assignee: Tata Consultancy Services Limited, Mumbai (IN)

(21) Appl. No.: 17/376,663

(22) PCT Filed: Jan. 24, 2020
(86) PCT No.: PCT/IB20/50569

§ 371 Date: Jul. 15, 2021

(30) Foreign Application Priority Data
Jan. 25, 2019 (IN) 201921003219

(51) Int. Cl. G05B 19/418

(52) U.S. Cl. CPC G05B 19/41865; G05B 19/41885; G05B 2219/32365

(57) ABSTRACT

This disclosure relates generally to system and method for managing dynamically adaptive supply network. The method includes simulating, by an exogenous model, the supply network in an analytical modeling language using at least a data populated from the supply network through a sensory data processing framework. The exogenous model provides a plurality of candidate analytical solutions corresponding to an event condition associated with the supply network based on the simulation. Corresponding to the event condition in a global context of the supply network, a satisfiable solution is identified. An endogenous model corresponding to the supply network is modified based on the satisfiable solution to obtain a modified endogenous model. The modified endogenous model is transformed into a programming language to obtain an updated endogenous model. The supply network is modified as directed by the updated endogenous model.

### PRIORITY CLAIM

This application is a U.S. National Stage Filing under 35 U.S.C. § 371 and claims priority from International Application No. PCT/IB2020/050569, filed on Jan. 24, 2020 which application claims priority under 35 U.S.C. § 119 from Indian Application No. 201921003219, filed on Jan. 25, 2019. The entire contents of the aforementioned application are incorporated herein by reference.

### TECHNICAL FIELD

The disclosure herein generally relates to dynamic adaptive supply networks, and, more particularly, to method and system for managing dynamically adaptive supply network.

### BACKGROUND

Modern enterprises operate in a highly dynamic environment wherein changes due to a variety of external drivers require rapid responses within a highly constrained setting. For instance, an autonomous manufacturing plant may assume a modular form having multiple subsystems operating in such a manner that one unit need not know details of other units. In other words, in such an autonomous plant other nodes would be oblivious of developments occurring at one unit, and thus may continue to operate locally optimally. The aforementioned scenario may impose certain limitations since the local units operate without having complete information about the entire supply network, i.e. without global context.

### SUMMARY

Embodiments of the present disclosure present technological improvements as solutions to one or more of the above-mentioned technical problems recognized by the inventors in conventional systems. For example, in one embodiment, a method for managing dynamically adaptive supply network is provided. The method includes simulating, by an exogenous model, the supply network in an analytical modeling language using at least a data populated from the supply network through a sensory data processing framework, via one or more hardware processors. Further, the method includes providing, by the exogenous model, a plurality of candidate analytical solutions corresponding to an event condition associated with the supply network based on the simulation, via the one or more hardware processors. Furthermore, the method includes identifying, from amongst the plurality of candidate analytical solutions, a satisfiable solution to the event condition in a global context of the supply network, via the one or more hardware processors. Moreover, the method includes transforming suitably an endogenous model corresponding to the supply network based on the satisfiable solution to obtain a modified endogenous model, via the one or more hardware processors. Also, the method includes transforming the modified endogenous model into a programming language to obtain an updated endogenous model, via the one or more hardware processors. Also, the method includes modifying the supply network as directed by the updated endogenous model, via the one or more hardware processors.

In another aspect, a system for managing dynamically adaptive supply network is provided. The system includes a memory storing instructions; one or more communication interfaces; and one or more hardware processors coupled to the memory via the one or more communication interfaces, wherein the one or more hardware processors are configured by the instructions to simulate, by an exogenous model, the supply network in an analytical modeling language using at least a data populated from the supply network through a sensory data processing framework. Further, the one or more hardware processors are configured by the instructions to provide, by the exogenous model, a plurality of candidate analytical solutions corresponding to an event condition associated with the supply network based on the simulation. Furthermore, the one or more hardware processors are configured by the instructions to identify, from amongst the plurality of candidate analytical solutions, a satisfiable solution to the event condition in a global context of the supply network. Moreover, the one or more hardware processors are configured by the instructions to transform suitably an endogenous model corresponding to the supply network based on the satisfiable solution to obtain a modified endogenous model. Also, the one or more hardware processors are configured by the instructions to transform the modified endogenous model into a programming language to obtain an updated endogenous model. Also, the one or more hardware processors are configured by the instructions to modify the supply network as directed by the updated endogenous model.

In yet another aspect, a non-transitory computer-readable medium having embodied thereon a computer program for executing a method for managing dynamically adaptive supply network is provided. The method includes simulating, by an exogenous model, the supply network in an analytical modeling language using at least a data populated from the supply network through a sensory data processing framework, via one or more hardware processors. Further, the method includes providing, by the exogenous model, a plurality of candidate analytical solutions corresponding to an event condition associated with the supply network based on the simulation, via the one or more hardware processors. Furthermore, the method includes identifying, from amongst the plurality of candidate analytical solutions, a satisfiable solution to the event condition in a global context of the supply network, via the one or more hardware processors. Moreover, the method includes transforming suitably an endogenous model corresponding to the supply network based on the satisfiable solution to obtain a modified endogenous model, via the one or more hardware processors. Also, the method includes transforming the modified endogenous model into a programming language to obtain an updated endogenous model, via the one or more hardware processors. Also, the method includes modifying the supply network as directed by the updated endogenous model, via the one or more hardware processors.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1A illustrates an exemplary supply network having an event condition, according to an example embodiment of the present disclosure.

FIG. 1B illustrates an exemplary decision making in response to the event condition at the supply network of FIG. 1A, according to an example embodiment of the present disclosure.

FIG. 2 illustrates a networking environment implementing a system for managing a dynamically adaptive supply network, according to an example embodiment of the present disclosure.

FIG. 3 is a functional block diagram for a system for dynamically managing an adaptive supply network, according to an example embodiment of the present disclosure.

FIG. 4 is a flow diagram illustrating a method for dynamically managing an adaptive supply network, according to an example embodiment of the present disclosure.

FIG. 5 illustrates an example process flow for dynamically managing an adaptive supply network, according to an example embodiment of the present disclosure.

### DETAILED DESCRIPTION

Modern enterprises typically have multiple subsystems, and the subsystems may have multiple components. The subsystems and corresponding components may form an adaptive supply network. The adaptive supply network is one in which a perfect understanding of individual parts do not automatically convey a perfect understanding of entire supply network's behavior. Said supply network exhibits dynamic interactions in form of networks associated with the subsystems, and hence are complex. Moreover, the relationships of these dynamic networks are not a mere aggregation of the subsystems which are individual static entities, so behavior of the ensemble (or the supply network) cannot be predicted by the behavior its components (i.e. the subsystems). Corresponding to event conditions in the supply networks, such networks may be adaptive since the individual subsystems may collectively behave in a manner so as to self-organize themselves, and hence are termed as dynamic supply networks. For the brevity of description, such dynamic adaptive supply networks may be referred to as ‘supply networks’ hereinafter.

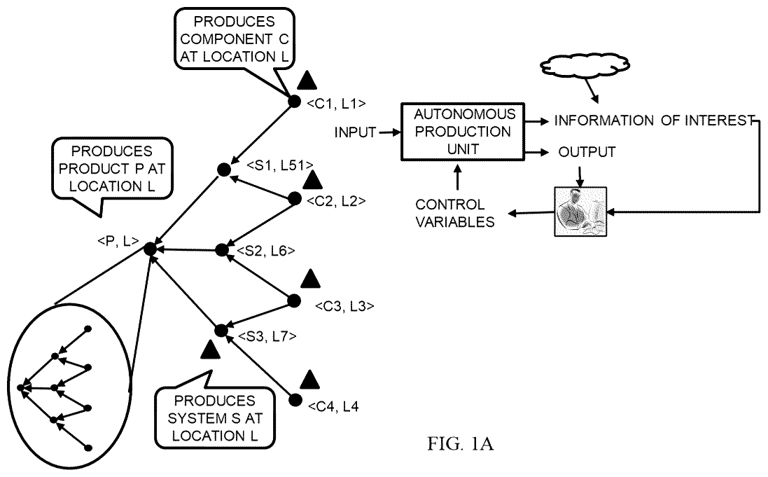

Said supply network may be represented in form of a graph having nodes and edges. In an enterprise, for instance an autonomous manufacturing plant, one of the subsystems may be oblivious of any development at other subsystems since said subsystems are operating autonomously. This scenario is explained with reference to FIG. 1A below.

Referring to FIG. 1A, a supply network 100 of a manufacturing enterprise producing product P is shown. The supply network 100 is shown to include sub-systems S₁, S₂ and S₃. In turn, sub-system S₁ is an assembly of components C₁ and C₂, sub-system S₂ is an assembly of components C₂ and C₃, and sub-system S₃ is an assembly of components C₃ and C₄.

Each node of the supply network 100 denotes an autonomous manufacturing unit at a specific location. The nodes are connected through edges, where each edge denotes a channel for taking deliverables produced at one location to another. Additionally or alternatively an edge may also denote channel for information exchange. Autonomous manufacturing unit, in turn, can be expanded into a supply network as shown inset FIG. 1A where a node denotes a work-shade and an edge denotes a channel for transporting goods produced. A work-shade, in turn, can be expanded into a supply network where a node denotes a physical machine and/or workstation used for manufacturing and an edge denotes, say, a conveyer belt connecting two machines. In short, the supply network exhibits a fractal nature thus requiring analysis to be performed at different levels of detail. In an embodiment, the supply network may include a hierarchy of subsystems having a plurality of subsystems arranged in a fractal pattern. For the brevity of description, embodiments are considered to two levels of hierarchy only, however, the hierarchy of subsystems may include more than two levels. Also, herein for the purpose of description, the supply network is shown and described in context of a vehicle manufacturing plant, however the supply network is not limited to a vehicle manufacturing plant but can be extended to any other application dealing with a complex supply network.

At macro level, each node is an autonomous production unit capable of producing the desired number of artefacts i.e. components or systems or products. Autonomy dictates that one node need not know the details of other nodes for executing its mandated production schedule. Considering that the product is manufactured as per the aforementioned rules:

P=Assembly(S₁,S₂,S₃),

S₁=Assembly(C₁,C₂).

S₂=Assembly(C₂,C₃) and

S₃=Assembly(C₃,C₄).

Therefore, to produce 100 quantities of P, the supply network may be operating as per the following production schedule: 100 quantities each of S₁, S₂, S₃, C; and C₄ and 200 quantities each of C₂ and C₃. The supply network 100 may be vulnerable to various factors affecting the production at a location.

Referring to FIG. 1B, and assuming a situation where production at locations L₅ and L₆ is affected due to local event conditions. Assuming that analysis of local event conditions reveal drop in production of S₁ and S₂ from 100 units to 80 and 60, respectively. As the supply network 100 is autonomous, other nodes may be oblivious of these developments and may continue to produce as per the original schedule. This may lead to further problems at locations L₅ and L₆. Thus, without having information about the entire supply network i.e. global context, this problem cannot be resolved satisfactorily.

Assuming that the analysis of the supply network 100 leads to the problem resolution strategy—“slow down production at all other locations till situation at L₅ and L₆ is back to normal”. This statement does not state clearly reduction of production “by how much, where and for how long”. For instance, (i) It is not clear whether the production be reduced to 80 units or 60 units or a randomly chosen value in 60-80 range or to the number when same problem occurred last? (ii) Further, it is not defined whether the reduction in production be same at all the locations or random or follow the precedence? (iii) Also, not clearly mentioned whether the duration of reduced production is based on intuition or follow the precedence? As can be seen, twenty four combinations may have to be examined to figure out which combinations leads to the best result. As there is time dimension involved, it may be critical to know ramifications of local actions in future. Furthermore, vulnerability of supply network to problems also needs to be considered in arriving at the right combination. The geographically distributed nature of supply network may introduce time delays which further exacerbate the problem.

Once a suitable strategy is arrived at, another challenge is in implementing it. As modern enterprises make extensive use of software systems, implementation of strategy involves reconfiguration or modification of the various software systems. Moreover, it is pertinent to test said implementation for correctness in a manner that is least intrusive as well as expensive as regards time, effort and cost.

Conventionally, primary reliance is on human experts to arrive at a solution when faced with challenges such as mentioned above. Tool support is available to address static situations, for instance, what should the production schedule be for each node of the supply network given a set of constraints. However, there is little help on hand to cater to the changes to be incorporated in the operation of supply networks in the light of local perturbations. Various reasons attributed to manage schedules during local perturbations, include, but are not limited to, inability to stitch together information pertaining to the global context (of the supply network), inability to keep global context in synchronization with the reality i.e. distributed local contexts, inability to support what-if scenario playing to arrive at good enough strategy, inability to support simulation in presence of uncertainty, inability to incorporate learning, and inability to decide the best possible implementation for the strategy.

Various embodiments disclosed herein provide method and system for managing dynamically adaptive supply networks that provides for the aforementioned challenges and other challenges known with regard to management of the dynamically adaptive supply networks. In an embodiment, the disclosed method provides a model-based data-driven evidence-backed approach to manage dynamically adaptive supply network. In an embodiment, the disclosed system is capable of modeling the supply network, and monitoring perturbations in the supply network by enabling the supply network with a sensor data processing framework. Herein, an important contribution of the disclosed embodiments is to simulate the supply network in an analytical modeling language that is capable of communicating the real-time condition of the supply network. In other words, said modeling language is necessary and sufficient to perform the kind of communication needed, and allow for analysis of the model. Said analysis enables the system to provide solutions to the perturbations and/or disturbances in the supply network. Herein, it will be understood that since the analysis is ‘data-driven’, wherein data is obtained via the sensory data processing framework, solution to objective functions indicative of optimization of the supply network may yield results that can be easily implemented. Moreover, since said model is amenable to data-driven approach, it is capable of providing evidence of the most optimal solution. Based on analysis of the model, the disclosed system may provide ramifications and/or recommendations of the changes to be done for optimization of the supply network. The system further includes an endogenous model of supply network, where the endogenous model replicates a software system that is capable of controlling functions of the supply network. Said endogenous model obtains recommendations concerning the changes and applies the same for optimal functioning of the supply network.

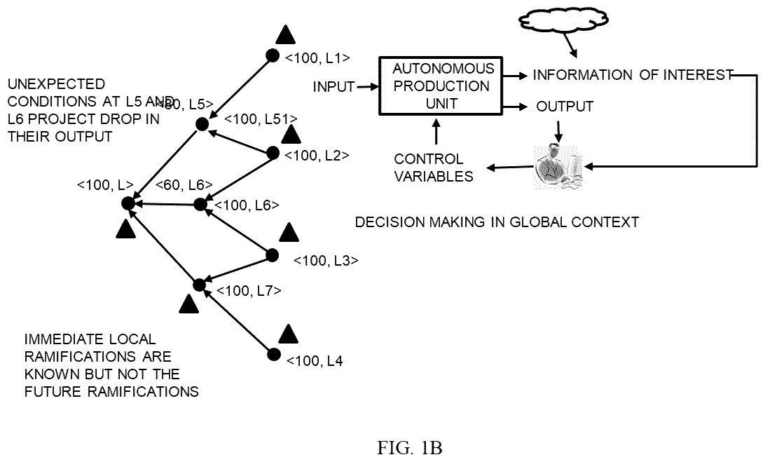

Herein, it will be understood that for the brevity of description the embodiments are explained in the context of a supply network. However, it will be understood that the embodiments disclosed herein are equally applicable for enterprises of future which are dynamic ecosystems. A detailed description of the above described system for managing dynamically adaptive network is shown with respect to illustrations represented with reference to FIGS. 2 through 6.

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Referring now to the drawings, and more particularly to FIG. 2 through 6, where similar reference characters denote corresponding features consistently throughout the figures, there are shown preferred embodiments and these embodiments are described in the context of the following exemplary system and/or method.

FIG. 2 illustrates a network environment 200 implementing a system 202 for managing dynamically adaptive supply network, according to an embodiment of the present subject matter. The system 202 includes an exogenous model for simulating a network, for example the supply network 100 (FIG. 1A) in an analytical modeling language. As already described, the supply network exhibits a fractal nature thus requiring an analysis to be performed at different levels of detail. Moreover, the supply network exhibits a level of uncertainty due to autonomous nature thereof, as previously explained. An important aspect of the disclosed embodiments is that analytical modeling language supports specification of uncertainty and the fractal pattern of the supply network. In an embodiment, the analytical modeling language is built on actor model of computation for specifying the exogenous model.

In an embodiment, the analytical modeling language may be kernel language. The kernel language for simulating the exogenous model, and the simulation of the exogenous model of an enterprise (for example, a supply network) is further described in the Indian Patent application no. 3930/MUM/2013 titled, “System and method for modelling and simulating a decision making process of an enterprise” and is incorporated herein by reference. The analytical modeling language is based on the principles of separation of concerns and purposive meta-modelling. Said language is defined in terms of generic concepts such as event, property, interface, component, composition, and goal. They constitute a minimal set of concepts necessary and sufficient for enterprise (or supply network) specification. The core language can be seen as a meta-model template where the generic concepts are placeholders. The template emits the desired purposive meta-model through a process of instantiation wherein the placeholder generic concepts are replaced by purpose-specific concepts. This makes it possible to establish relationships across multiple purposive meta-models and also impart consistent semantics. The meta-modelling approach is suited to the open-ended problem space of modelling of the supply network since any number of meta-models can be defined, relationships spanning across the various meta-models specified and the desired semantic meaning imparted and so on.

In an embodiment, the exogenous model is simulated by utilizing a training data associated with the context of the supply network. The training data may include domain knowledge of the supply network. In an example embodiment, said domain knowledge may include, but is not limited to the configuration, internal properties, functions of said subsystems, events to be handled by the subsystems, a composition structure of units to interact with other subsystems participating to perform a task, behavior of the one or more subsystems utilizing other units to achieve the goals, and parametric properties influencing the goals and the behavior of the subsystems. The system may specify tuples for the configuration of the subsystems, and translates said configuration into an analytic modelling language. The subsystem configuration is simulated using the analytical modeling language to analyze decision making of the enterprise corresponding to the subsystems for subsystem configuration.

The exogenous model is automatically populated with data from cyber physical reality using a sensory data processing framework of the system network. Herein, the sensory data processing framework may refer to an industrial internet of things (IoT) framework or a smart safe environment. The sensory data processing framework may track subsystems and assets thereof via metadata properties or attributes thereof converted into digital form by means of sensors embodied therein. Each of said attributes can be associated with a corresponding sensor for continuous monitoring. Industrial Internet applications may range from location based tracking of assets, remote management of assets, preventive or predictive maintenance, and so on. The digitally augmented assets facilitate in capturing different meta properties of assets such as static property, sensor based dynamic property, lookup based property, computed property, and so on.

Each of said attributes can be associated with a corresponding sensor for continuous monitoring. Industrial Internet applications may range from location based tracking of assets, remote management of assets, preventive or predictive maintenance, and so on. The digitally augmented assets facilitate in capturing different meta properties of assets such as static property, sensor based dynamic property, lookup based property, computed property, and so on.

Although the present disclosure is explained considering that the system 202 is implemented on a server, it may be understood that the system 202 may also be implemented in a variety of computing systems, such as a laptop computer, a desktop computer, a notebook, a workstation, a cloud-based computing environment and the like. It will be understood that the system 202 may be accessed by multiple contributors through one or more devices 206-1, 206-2 . . . 206-N, collectively referred to as devices 206 hereinafter, or applications residing on the devices 206. Examples of the devices 206 may include, but are not limited to, a portable computer, a personal digital assistant, a handheld device, a smartphone, a tablet Computer, a workstation and the like. The devices 206 are communicatively coupled to the system 202 through a network 208.

In an embodiment, the network 208 may be a wireless or a wired network, or a combination thereof. In an example, the network 208 can be implemented as a computer network, as one of the different types of networks, such as virtual private network (VPN), intranet, local area network (LAN), wide area network (WAN), the internet, and such. The network 206 may either be a dedicated network or a shared network, which represents an association of the different types of networks that use a variety of protocols, for example, Hypertext Transfer Protocol (HTTP), Transmission Control Protocol/Internet Protocol (TCP/IP), and Wireless Application Protocol (WAP), to communicate with each other. Further, the network 208 may include a variety of network devices, including routers, bridges, servers, computing devices, storage devices. The network devices within the network 108 may interact with the system 202 through communication links.

As discussed above, the system 202 may be implemented in a computing device 204, such as a hand-held device, a laptop or other portable computer, a tablet computer, a mobile phone, a PDA, a smartphone, and a desktop computer. The system 202 may also be implemented in a workstation, a mainframe computer, a server, and a network server. In an embodiment, the system 202 may be coupled to a data repository, for example, a repository 212. The repository 212 may store data processed, received, and generated by the system 202. In an alternate embodiment, the system 202 may include the data repository 212.

In an embodiment, the network environment 200 may be an IoT based environment comprising various hardware and software elements collectively configured to perform real-time data analytics in the smart computing environment, according to an exemplary embodiment of the disclosure. The IoT based platform backend may include a cloud server, for example the server 204 connected to a database, for example, the database 212. The system 200 further includes various IoT based devices, for example the devices 206 implemented on different smart devices such as smart phone, a telematics device, and so on enabling real-time analytics of sensor data. The system further includes various heterogeneous sensor devices, for example sensor devices 210-1, 210-2, 210-N (hereinafter collectively referred to as sensor devices 210) and so on, placed in the vicinity of smart computing environment connected with various IoT based devices 206. Alternatively, said sensor devices 210 may be embodied in the IoT based devices 206. Thus, the sensor devices 210 along with the IoT based devices 206 may collectively form an intelligent smart environment according to this exemplary embodiment.

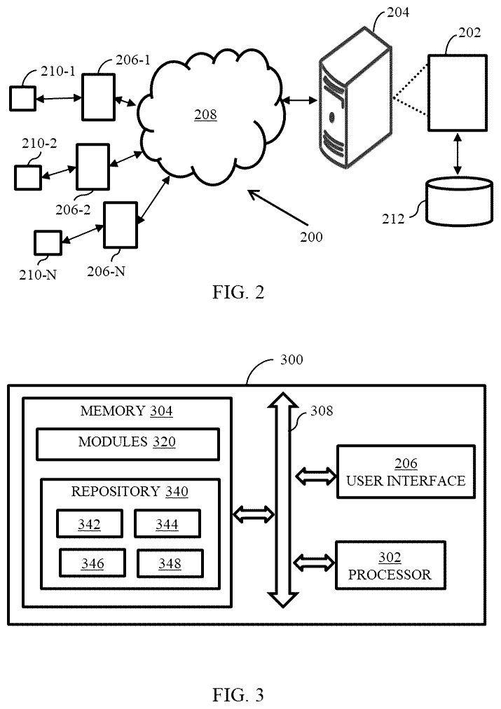

Further, as illustrated in FIG. 2, the network environment 200 supports various connectivity options such as BLUETOOTH®, USB, ZigBee and other cellular services. In an exemplary embodiment, the system 202 interfaces with sensors 210 such as GPS, accelerometers, magnetic compass, audio sensors, camera sensors, and so on. Based on the data collected from various sensors, the system 202 with the help of various hardware and software platforms, collectively performs the task of scalable data analytics on the captured sensor data in any smart computing environment. The network environment enables connection of devices 206 such as Smartphone with the server 204, and accordingly with the database 212 using any communication link including Internet, WAN, MAN, and so on. In an exemplary embodiment, the system 202 is implemented to operate as a stand-alone device. In another embodiment, the system 202 may be implemented to work as a loosely coupled device to the smart computing environment. The components and functionalities of the system 202 are described further in detail with reference to FIG. 3.

FIG. 3 illustrates a block diagram of a system 300 for managing dynamically adaptive network, in accordance with an example embodiment. The system 300 may be an example of the system 202 (FIG. 2). In an example embodiment, the system 300 may be embodied in, or is in direct communication with the system, for example the system 202 (FIG. 2).

The system 300 includes or is otherwise in communication with one or more hardware processors such as a processor 302, at least one memory such as a memory 304, and an I/O interface 306. The processor 302, memory 304, and the I/O interface 306 may be coupled by a system bus such as a system bus 308 or a similar mechanism. The I/O interface 306 may include a variety of software and hardware interfaces, for example, a web interface, a graphical user interface, and the like. The interfaces 306 may include a variety of software and hardware interfaces, for example, interfaces for peripheral device(s), such as a keyboard, a mouse, an external memory, and a printer. Further, the interfaces 306 may enable the system 300 to communicate with other devices, such as web servers and external databases. The interfaces 306 can facilitate multiple communications within a wide variety of networks and protocol types, including wired networks, for example, local area network (LAN), cable, and so on, and wireless networks, such as Wireless LAN (WLAN), cellular, or satellite. For the purpose, the interfaces 306 may include one or more ports for connecting a number of computing systems with one another or to another server computer. The I/O interface 306 may include one or more ports for connecting a number of devices to one another or to another server.

The hardware processor 302 may be implemented as one or more microprocessors, microcomputers, microcontrollers, digital signal processors, central processing units, state machines, logic circuitries, and/or any devices that manipulate signals based on operational instructions. Among other capabilities, the hardware processor 302 is configured to fetch and execute computer-readable instructions stored in the memory 304.

The memory 304 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 304 includes a plurality of modules 320 and a repository 340 for storing data processed, received, and generated by one or more of the modules 320. The modules 320 may include routines, programs, objects, components, data structures, and so on, which perform particular tasks or implement particular abstract data types. The repository 340, amongst other things, includes a system database 342 and other data 344. The other data 344 may include data generated as a result of the execution of one or more modules in the modules 320.

In an embodiment, the system 300 may create an exogenous model of the supply network, for example, the supply network 100 (FIG. 1A). The exogenous model is a model in which change comes from outside of the model and is unexplained by the model. The system 300 simulates, by the exogenous model, the supply network in an analytical modeling language. The system simulates the supply network using sensory data populated from the supply network through a sensory data processing framework, in addition to a training data (described with reference to FIG. 2) associated with modeling of exogenous model.

The sensory data processing framework herein refers to an Internet of Things (IoT) enabled framework. Herein, the supply network forms a smart ubiquitous environment. The sensory data processing framework is capable of providing suite of services for development and deployment of sensor-based applications in the smart ubiquitous computing environment. It will be understood that the environments in which smart ubiquitous devices are deployed are referred to as “smart spaces”. Smart ubiquitous computing devices are those that are developed and deployed in order to observe, monitor and track the state of various physical infrastructures, state physical objects, environment, human beings and their activities. For instance, herein the smart ubiquitous computing devices may be embodied in or associated with various devices and/or components of the supply network in order to observe, monitor and track the state thereof. Data associated with states of various devices and/or components of the supply network may be communicated by the system for simulating the exogenous model of the supply network.

In one embodiment, the present disclosure enables an Internet of Things (IoT) based platform, as described with reference to FIG. 1. Said IoT based platform may be a PaaS cloud computing platform that allows quick and easy development, deployment and administration of sensor driven applications. The IoT based platform interfaces with a heterogeneous set of sensors and devices (for example, devices 106 and sensors 110, FIG. 1) within the smart computing environment collecting sensor observations, storing the data in a database connected with the platform, performing scalable analytics on the data either within the vicinity of the smart computing environment on in a cloud, and so on. In this embodiment, the platform provide a suite of infrastructure services in the form of APIs and SDKs. IoT based platform provides a highly scalable platform for sensor integration, sensor data storage, analytics, rich query capabilities and visualization. The platform comprises a set of services related to sensor description, discovery, integration, sensor observation and measurement capture, storage and query in the form of APIs and libraries.

In general, smart spaces includes various categories of sensors, for example senor devices 110 (FIG. 1) adapted for sensing and observation of various parameters in the environment that may enable to perform analytics on them to alert the end-users about the consequence of changes in the state, if any. For example, sensors may be deployed to observe and track location of any physical object/entity, observe weather conditions to monitor natural calamities, observe traffic on the road to enable traffic shaping and vehicle surveillance systems, and so on. Such sensors may be embedded in physical entities and/or objects and things in the smart spaces. Many of said sensors may, directly or indirectly, be connected to the Internet. Many of the sensors may be deployed by organizations, companies or public sector entities such as city governments or utilities or government departments.

In a smart space environment associated with the supply network, the embodiments herein provision web-connected sensors and sensors available as part of smart mobile devices, for instance devices 206 (FIG. 2). Said sensors provisions for certain key requirements including sensor discovery, events monitoring, interfacing, query and tasking. Moreover, said sensors driven may be event driven and therefore includes capabilities such as event processing or stream processing. Additionally, said sensors may require support for various types of databases such as RDBMS, NOSQL and Object Stores, and so on, for scalable storage of different types of sensor observations. Also, the diversified domains may require specialized analytics and data visualization for deriving inferences and value addition. Said sensors perform on platforms that enable location based processing, spatial and spatio-temporal processing. Herein, it will be pertinent to note that said sensors may be suitable for multi-vendor generic sensor device management, data capture and observation processing.

Herein, the system 300 may be a unified system that facilitates sensor driven distributed application development, testing, deployment, application life cycle management, analytics service, data storage service, sensor services and modeling and simulation for analytics. Also, the system 300 may enable comprehensive hosting of services such as sensor service, analytics service, identity and access control service, data storage service that are required for prompt and speed-up sensor application development. Further, the system 300 facilitates real-time development and deployment of sensor-based applications using a rich suite of services that enables sensor data reusability, data normalizing and data privacy. Since the system embodies capabilities of sensor data processing, this leads to reduction in costs and effort required for development and deployment of sensor based applications. Further, the system is deployed with specific focus on particular devices/assets in the supply network, it is bound with security and privacy policies of said supply network.

In an example scenario, an event condition may occur at least one subsystem of the supply network. The at least one event condition may include a perturbation in the supply network. Additionally or alternatively, the event condition may include identifying a new opportunity necessitating modifications to the supply network. Herein, the event condition may cause a change in parameters and/or operation of at least one subsystem of the supply network, which may affect the operation of the supply network in a global context. The terms ‘local context’ and the ‘global context’ are differentiated with regards to the existence of the event condition and effects thereof at the corresponding subsystem level and at the level of supply network, respectively. For example, as explained with reference to FIGS. 1A and 1B, the global context may refer to the event condition that may have ramifications globally across the plurality of subsystem of the supply network. It will be understood that the system 300 is capable of providing satisfiable solution that is satisfied in global context, meaning thereby that said satisfiable solution is arrived at considering vulnerability of the supply network to problems arising out of the event condition at a particular subsystem, and/or geographically distributed nature of the supply network that may introduce time delays.

In an embodiment, the system 300 is capable of identifying a localized context corresponding to at least one subsystem of the plurality of subsystems associated with the event condition. Upon identification of the event condition, the system 300 and in particular, simulation of the exogenous model provides a plurality of candidate analytical solutions of said event condition. For instance, in case of a perturbation in the example supply network described with reference to FIGS. 1A and 1B, the system 300 may provide candidate solutions pertaining to number of units to be produced, production location, production duration of the number of the units to be produced, and so on. It will be noted that the exogenous model may provide multiple candidate solutions in response to the event condition. The exogenous model may select one candidate solution as a ‘good enough if not the best’ solution from amongst the multiple candidate solutions. Herein, the exogenous model may select the ‘good enough if not the best’ solution to the event condition in a global context of the supply network.

In an embodiment, the system 300 may validate the candidate solution against undesirable ramifications across the supply network. In an embodiment, the system 300 may validate the candidate solution by simulating the same using the exogenous model.

The system 300 includes an endogenous model of the supply network. The system transforms the endogenous model based on the ‘good enough if not the best’ solution to obtain a modified endogenous model. The system 300 then transforms the modified endogenous model into a programming language so as to validate efficacy and effectiveness through testing. The transformation of the modified endogenous model provides an updated endogenous model. Herein, an example of the programmable language may be Scala, or any similar actor based language. The physical system of the supply network is governed by software systems, and the programming language is needed to codify said software systems. The correctness of the software programs is ensured using standard techniques such as software testing.

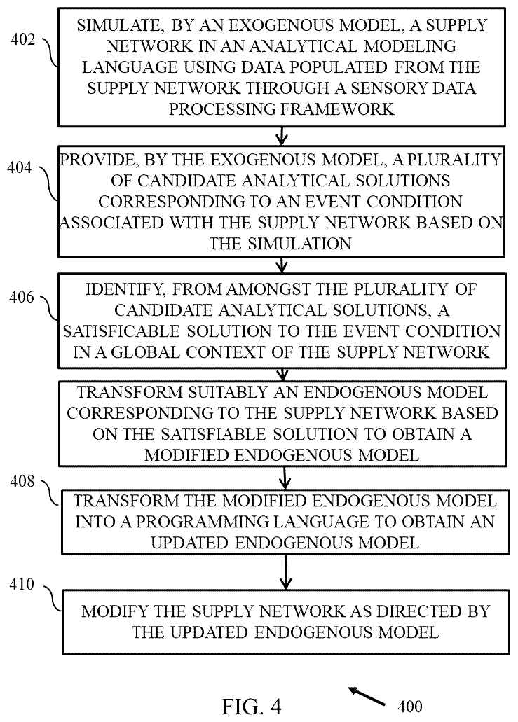

The system 300 modifies the supply network as directed by the updated endogenous model. In an embodiment, the system modifies the supply network by implementing the satisfiable solution to control the supply network. Additionally or alternatively, the modification of the subsystems of the supply network may encompass reconfiguration of various software systems configured to operate the subsystems of the supply network. Herein, the endogenous models enables the system to test implementation of said modifications for correctness in a manner that is least intrusive as well as expensive as regards time, effort and cost. In an embodiment, the system may further be capable of validating the modified supply network for the desired behavior. A flow diagram explaining functioning of the disclosed system is described further in detail with reference to FIG. 4.

Referring now to FIG. 4, a flow diagram of a method 400 for managing dynamically adaptive network is described, in accordance with an example embodiment. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communication network. The order in which the method 400 is described is not intended to be construed as a limitation, and any number of the described method blocks can be combined in any order to implement the method 400, or an alternative method. Furthermore, the method 400 can be implemented in any suitable hardware, software, firmware, or combination thereof. In an embodiment, the method 400 depicted in the flow chart may be executed by a system, for example, the system 202 of FIG. 2. In an example embodiment, the system 202 may be embodied in an exemplary computer system.

At 402, the method 400 includes simulating, by an exogenous model, the supply network in an analytical modeling language using data. As previously described, the data includes a training data and sensory data populated from the supply network through a sensory data processing framework. Herein, the sensory data processing framework may be an IoT based framework.

At 404, the method 400 includes providing, by the exogenous model, a plurality of candidate analytical solutions corresponding to an event condition associated with the supply network based on the simulation. In an embodiment, the event condition may be a perturbation in the supply network. Alternatively or additionally, the event condition may include identification of a new opportunity necessitating modifications to the supply network. Herein, the solution is an optimal solution to the event condition in a global context of the supply network.

At 406, the method 400 includes identifying, from amongst the plurality of candidate analytical solutions, a satisfiable solution to the event condition in a global context of the supply network. At 408, the method includes transforming suitably an endogenous model corresponding to the supply network based on the satisfiable solution to obtain a modified endogenous model. At 410, the method 400 includes transforming the modified endogenous model into a programming language to obtain an updated endogenous model. At 412, the method 400 includes modifying the supply network as directed by the updated endogenous model.

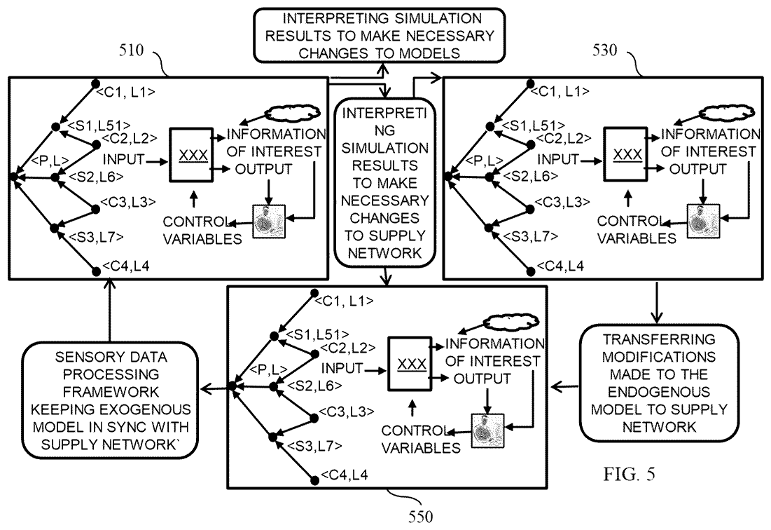

FIG. 5 illustrates a process flow for managing dynamically adaptive supply networks, in accordance with an example embodiment. Herein, the technique is model-based data-driven evidence-backed approach. Herein it will be understood that even though the approach is illustrated in supply network context, the disclosed embodiments are equally applicable for enterprise which includes dynamic ecosystem.

Referring now to FIG. 5, the ecosystem for the disclosed embodiments is shown to include a supply network 510 for an enterprise, an exogenous model 530 corresponding to the supply network 510, and an endogenous system 550 corresponding to the supply network 510.

The supply network 510 denotes a ‘reality’ of the entire supply network i.e. autonomous production units at different locations, cyber physical details such as physical machines, software systems controlling these machines, software systems providing coordination support, production schedules, past history in terms of problems and remedies, and all kinds of communications e.g. machine-to-machine, software-to-machine, machine-to-software, software-to-software and so on.

The exogenous model 530 denotes an abstract (i.e. devoid of unnecessary details) exogenous (i.e. outside-in perspective) purposive (i.e. specific to the problem situation) model of the reality (or the supply network). The exogenous model may be simulated in an analytical modelling language that builds on the actor model of computation for specifying this model. The analytical modeling language supports specification of uncertainty and the fractal concept of the supply network. Further, a simulator for this language is provided to support what-if scenario playing even in presence of uncertainty.

Herein, the exogenous model is a good enough representation of real supply network 510, hence simulation using real life data may lead to good enough solution. A sensory data processing framework may automatically populate the exogenous model with values from cyber physical reality. An example sensory data processing framework is disclosed in India patent application no. 2651/MUM/2011 titled “Computer Platform for Development and Deployment of Sensor Data based Applications and Services”, and incorporated herein by reference. Analysis of simulation results from the exogenous model 530 may enable identification of a satisfiable solution. As the satisfiable solution is arrived at using an abstract model of the reality, it is possible that the solution can be implemented in multiple ways. A non-intrusive and cost-effective implementation of the solution may be achieved by modeling an endogenous model of the supply network, as described below.

The endogenous model 550 presents an inside-out perspective of the supply network, and has a one-to-one correspondence with the reality (supply network 510). The endogenous model 550 may be specified in a programming language based on the actor model of computation. In a sense, the endogenous model 550 represents a digital incarnation of the reality i.e. a test environment. Thus, through testing, equivalence of the exogenous and endogenous models is established. As the endogenous model has one-to-one correspondence with the reality, modifying the reality i.e., the various software systems comprising the cyber physical reality, is quite straight forward.

The aforementioned system comprising the endogenous model and exogenous model of the supply network may be utilized for model-based data-driven evidence-backed approach to manage dynamically adaptive supply networks. In an embodiment, the method includes human-in-control automation-aided method, to close the loop depicted in FIG. 5. In particular, the method includes observing the real world or the supply network using the sensory data framework. In case anything irregular is identified, the system populates appropriate abstract exogenous purposive model with data from real world using at least the sensory data processing framework. The system may perform what-if analysis over the exogenous model to arrive at the most optimal solution. The system populates appropriate endogenous model with the same data from real world (or the supply network), and establishes equivalence between exogenous and endogenous models through testing. The system modifies the real world (or the supply network 510) as directed by the endogenous model 550. If however, the system identifies the supply network behaving regularly, the system may continue observing.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address unresolved problem of handling event conditions in adaptive supply networks. The embodiment, thus provides a method and system for dynamically handling event conditions in adaptive supply networks. Unlike conventional systems, the disclosed system is capable of handling dynamic conditions in a supply network having multiple autonomous subsystems. For example, the disclosed system is configured to cater to the changes to be incorporated in the schedule in the light of global perturbations. In particular, the system includes components capable of stitching together information pertaining to the global context, keeping global context in synchronization with the reality i.e. distributed local contexts, ability to support what-if scenario playing to arrive at good enough strategy, ability to support simulation in presence of uncertainty, ability to incorporate learning, and ability to decide the best possible implementation for the strategy. Due to aforementioned abilities, the disclosed system is capable of managing dynamically adaptive supply networks during event conditions.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for managing dynamically adaptive supply network, comprising:
simulating, by an exogenous model, the supply network in an analytical modeling language using at least a data populated from the supply network through a sensory data processing framework, via one or more hardware processors; providing, by the exogenous model, a plurality of candidate analytical solutions corresponding to an event condition associated with the supply network based on the simulation, via the one or more hardware processors;
identifying, from amongst the plurality of candidate analytical solutions, a satisfiable solution to the event condition in a global context of the supply network, via the one or more hardware processors;
transforming suitably an endogenous model corresponding to the supply network based on the satisfiable solution to obtain a modified endogenous model, via the one or more hardware processors;
transforming the modified endogenous model into a programming language to obtain an updated endogenous model, via the one or more hardware processors; and modifying the supply network as directed by the updated endogenous model, via the one or more hardware processors.

2. The processor implemented method of claim 1, wherein the sensory data processing framework comprises a smart space environment having a plurality of sensors associated with a plurality of assets of the supply network, the plurality of sensors capable of capturing the data from the plurality of assets in real-time.

3. The processor implemented method of claim 1, wherein the supply network comprises a hierarchy of subsystems having a plurality of subsystems arranged in a fractal pattern.

4. The processor implemented method of claim 3, wherein the analytical modeling language is built on an actor model of computation for specifying the exogenous model.

5. The processor implemented method of claim 4, wherein the analytical modeling language supports the fractal pattern of the supply network.

6. The processor implemented method of claim 3, wherein the satisfiable solution for a localized context of the supply network does not lead to undesirable ramifications across the supply network.

7. The processor implemented method of claim 1, wherein the event condition comprises at least one of a perturbation in the supply network and a new opportunity necessitating modifications to the supply network.

8. The processor implemented method of claim 6, further comprising validating the satisfiable solution against the undesirable ramifications across the supply network.

9. The processor implemented method of claim 1, wherein modifying the supply network comprises implementing the satisfiable solution by the endogenous model to control the supply network.

10. A system (300) for managing dynamically adaptive supply network, comprising:
a memory (302) storing instructions;
one or more communication interfaces (306); and
one or more hardware processors (304) coupled to the memory (302) via the one or more communication interfaces (306), wherein the one or more hardware processors (304) are configured by the instructions to:
simulate, by an exogenous model, the supply network in an analytical modeling language using at least a data populated from the supply network through a sensory data processing framework;
provide, by the exogenous model, a plurality of candidate analytical solutions corresponding to an event condition associated with the supply network based on the simulation;
identify, from amongst the plurality of candidate analytical solutions, a satisfiable solution to the event condition in a global context of the supply network;
transform suitably an endogenous model corresponding to the supply network based on the satisfiable solution to obtain a modified endogenous model;
transform the modified endogenous model into a programming language to obtain an updated endogenous model; and
modify the supply network as directed by the updated endogenous model.

11. The system of claim 10, wherein the sensory data processing framework comprises a smart space environment having a plurality of sensors associated with a plurality of assets of the supply network, the plurality of sensors capable of capturing the data from the plurality of assets in real-time.

12. The system of claim 10, wherein the supply network comprises a hierarchy of subsystems having a plurality of subsystems arranged in a fractal pattern.

13. The system of claim 12, wherein the analytical modeling language is built on an actor model of computation for specifying the exogenous model.

14. The system of claim 13, wherein the analytical modeling language supports the fractal pattern of the supply network.

15. The system of claim 12, wherein the satisfiable solution for a localized context of the supply network does not lead to undesirable ramifications across the supply network.

16. The system of claim 10, wherein the event condition comprises at least one of a perturbation in the supply network and a new opportunity necessitating modifications to the supply network.

17. The system of claim 15, wherein the one or more hardware processors are further configured by the instructions to validate the satisfiable solution against undesirable ramifications across the supply network.

18. The system of claim 10, wherein to modify the supply network, the one or more hardware processors are further configured by the instructions to implementing the satisfiable solution by the endogenous model to control the supply network.

19. One or more non-transitory machine readable information storage mediums comprising one or more instructions which when executed by one or more hardware processors cause:
simulating, by an exogenous model, the supply network in an analytical modeling language using at least a data populated from the supply network through a sensory data processing framework, via one or more hardware processors; providing, by the exogenous model, a plurality of candidate analytical solutions corresponding to an event condition associated with the supply network based on the simulation, via the one or more hardware processors;
identifying, from amongst the plurality of candidate analytical solutions, a satisfiable solution to the event condition in a global context of the supply network, via the one or more hardware processors;
transforming suitably an endogenous model corresponding to the supply network based on the satisfiable solution to obtain a modified endogenous model, via the one or more hardware processors;
transforming the modified endogenous model into a programming language to obtain an updated endogenous model, via the one or more hardware processors; and modifying the supply network as directed by the updated endogenous model, via the one or more hardware processors.
